(19) United States
(12) Patent Application Publication
(10) Pub. No.: US 2005/0131851 A1
(43) Pub. Date: Jun. 16, 2005

(54) Test strategy generator

(76) Inventors: Harald Seeger, Stuttgart (DE); Albrecht Schroth, Herrenberg (DE)

Correspondence Address: PERMAN & GREEN, 425 POST ROAD, FAIRFIELD, CT, 06824, US

(21) Appl. No.: 10/492,066

(22) PCT Filed: May 24, 2002
(86) PCT No.: PCT/EP02/05689

(30) Foreign Application Priority Data
Nov. 20, 2001 (EP) 01127639.1

(51) Int. Cl. G06N 5/04

(52) U.S. Cl. 706/60

(57) ABSTRACT

A method of managing a communication network is described. Test devices and a physical layer management system are provided for managing the physical attributes of the communication network. Tests are performed within the communication network using the test devices and managing the tests by a test strategy generator. The test strategy generator is comprised within the physical layer management system.

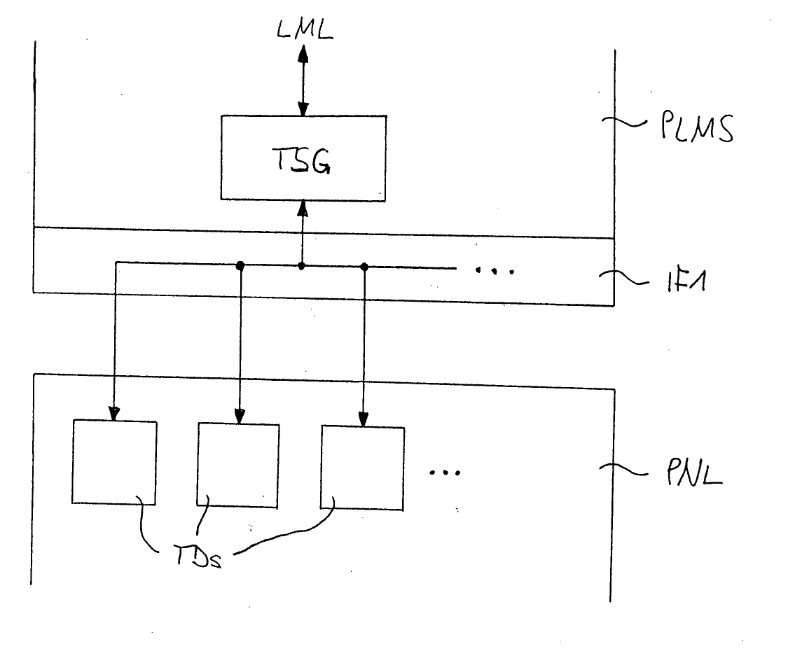

### BACKGROUND OF THE INVENTION

The invention relates to the management of a communication network.

Such a communication network comprises transmission equipment, i.e. network elements, which are managed by a logical and a physical management layer. Furthermore, test devices are provided for performing tests within the communication network.

It is known to couple the test devices with a physical layer management system. The physical layer management system then can call the test device; the test device performs its test and provides the results back to the physical layer management system, which processes the results.

This procedure requires that the physical layer management system exactly knows the kind of test devices, which are present and in particular the kind of results that these test devices are able to provide. Only under these conditions, the physical layer management system is able to process the results received from the test devices. Such procedure is quite stringent and inflexible.

### OBJECT AND ADVANTAGES OF THE INVENTION

It is therefore an object of the invention to provide an improved management of a communication network.

This object is solved by the subject matters of the independent claims.

According to the invention, a test strategy generator is present to manage the tests of the communication network. For that purpose, the test strategy generator comprises some kind of artificial intelligence. The test strategy generator therefore is able to establish the sequence, number and/or kind of tests depending on the number and/or kind of connected test devices as well as depending on the result/s of previous tests. Furthermore, rules are given to build up the sequence of tests.

The invention has the advantage that the tests of the communication network are not only created automatically but also in a manner adapted to the specific case. This leads to a very flexible and efficient use of the available test devices.

In an embodiment of the invention, defaults of tests and/or test sequences are provided which may then be adapted by the test strategy generator in dependence of the number and/or kind of connected test devices and of the results of preceding tests.

The invention also provides the possibility to realize a plug-and-play functionality. If a new test device is introduced, it is recognized by the test strategy generator. It is therefore possible to upgrade the physical layer management system very flexible without any downtime or need for synchronization.

Further embodiments of the invention are provided in the other dependent claims.

### DETAILED DESCRIPTION OF EMBODIMENTS OF THE INVENTION

The only FIGURE shows an embodiment of a network management system according to the invention.

A communication network of e.g. a company comprises a large number of network elements. These network elements are the active transmission devices, which are necessary to build up the communication network, e.g. transmitters, receivers, amplifiers, multiplexers, and so on. The network elements are connected by passive transmission devices, e.g. fibers, patch panels.

Furthermore, a number of test devices TDs are provided for performing tests within the communication network. These tests may be carried out to evaluate the quality of the communication network, e.g. in connection with a preventive maintenance. As well, the tests may be carried out in cases of a failure within the communication network. As an example, a power monitoring device or an optical spectrum analyser or a optical time domain reflectometer may be coupled as test devices TDs to the communication network.

All network elements and all test devices TDs of the communication network relate to the so-called physical network layer PNL. This physical network layer PNL may furthermore comprise other network objects like buildings, floors and rooms where the objects of the communication network are located.

A physical layer management system PLMS is provided for managing the network elements and the test devices TDs within the physical network layer PNL.

The physical layer management system PLMS is coupled with the physical network layer PNL and in particular with the test devices TDs via a first interface IF1. The physical layer management system PLMS is also coupled with a logical management layer LML via a second interface (not shown in the FIGURE). In particular, both interfaces are generic and standardized.

As already mentioned, the test devices TDs are provided for performing tests within the communication network. For managing the tests, a test strategy generator TSG is generated within the physical layer management system PLMS. This test strategy generator TSG is coupled with the test devices TDs via the first interface IF1. In particular, the first interface IF1 may comprise the necessary application hardware and software like graphical user interfaces and/or device drivers or the like.

The first interface IF1 provides a standardized connection to the test devices TDs, which are present. The first interface IF1 is realized such that it automatically recognizes the number and/or kind of test devices TDs, which are connected to it. The first interface IF1 also accepts and recognizes the registration of new test devices TDs, e.g. via plug-and-play. The test devices TDs may come from different vendors. The first interface IF1 is able to provide this information to the test strategy generator TSG.

In order to realize the mentioned plug-and-play functionality, the test devices TDs provide at least some specific minimum features, which are known to the test strategy generator TSG. After the features of a new test device are forwarded to the test strategy generator TSG, it assigns at least the mentioned specific minimum features to the new test device TD. If it is a test device, which is completely known to the test strategy generator TSG, then the test strategy generator TSG assigns all known features to the new test device TD.

On the basis of the number and/or kind of connected test devices TDs, the test strategy generator TSG selects a number, sequence and/or kind of tests. For that purpose, defaults of tests and/or test sequences are present within the test strategy generator TSG, which are then adapted to the specific number and/or kind of connected test devices TDs.

When selecting the number, sequence and/or kind of tests, the result/s of preceding tests are considered by the test strategy generator TSG. This means that in particular the sequence of the tests depends on the results of one of the previously performed tests. The same is possible for the test devices TDs used for performing the tests. Here it is possible that different test devices TDs are used depending on the results of preceding tests. All preceding information may be stored in a database within the test strategy generator TSG.

The sequence may also depend on user-defined optimisation strategies like an optimisation for transmission speed or an optimisation for transmission quality. As well, performance requirements like transmission speed, bit-error rate, and the like, of the logical management layer LML and/or the physical layer management system PLMS may be used as inputs of the test strategy generator TSG.

Therefore, the test strategy generator TSG does not only carry out a fixed list of subsequent tests but is able to built up and/or modify and/or optimise a variable sequence of tests which is adapted to the specific case. Insofar, the test strategy generator TSG comprises some kind of artificial intelligence.

The test strategy generator TSG creates the sequence of tests based on given rules, in particular so-called if-then rules. This is explained in connection with the following example:

It is assumed that the bit-error rate shall be measured for a specific fiber for e.g. 10 Gbit/sec. A bit-error rate tester and an optical switch for coupling the tester with the fiber are present. As well, preceding parameters of bit-error rate tests are stored in a database.

Then the following rules are used: I) if the optical switch is present, ii) if the self-test of the optical switch is positive, iii) if the bit-error rate tester is present, iv) if the self-test of the bit-error rate tester is positive, and v) if the bit-error rate tester allows the measurement of the specific fiber with 10 Gbit/sec, then the test shall be carried out with the parameters of the preceding bit-error rate tests.

The following rules may be added: If an optical time domain reflectometer is present and if the self-test of this reflectometer is positive, then a prior test with the reflectometer is carried out with parameters of preceding tests. If the test with the reflectometer provides a result and if this result is similar to a reference value, only then the bit-error rate test is carried out. However, if the provided result differs from the reference value, then status information for the user is created.

As a result the test strategy created by the test strategy generator TSG depends on the rules, on the test devices which are actually present, on parameters of preceding tests and so on. The test strategy, therefore, is not only a rule-based expert system, but comprises the application of the rules, preceding parameters and so on, as well as the performance of the corresponding tests and measurements.

The tests are processed—as described—with the help of the test devices TDs. The first interface IF1 receives all results from the test devices TDs and provides these results to the test strategy generator TSG and the physical layer management system PLMS. The test strategy generator TSG uses these results—as outlined—for establishing and carrying out the sequence, number and/or kind of further tests to be performed.

The outcome of the test strategy generator TSG may be a status information or a detailed result which may consist of one or more measurement results of the test devices TDs.

The tests may also be initiated by the logical management layer LML via the physical layer management system PLMS. Insofar it is possible that a user initiates the tests by using respective equipment, e.g. an input device of a computer system of the logical management layer LML.

As described, the results are received by the test strategy generator TSG. From there, the results may be provided to the physical layer management system PLMS and/or to the logical management layer LML. Insofar, the results may also be displayed to a user via a display device of a computer system of the logical management layer LML.

Furthermore, it is possible that detailed test results of different test devices which are performed on the same link, are condensed to a more abstract quality statement of a special link. Thus, the result of a test strategy is not displayed as a huge number of detailed information but as a response to the required optimisation strategy or performance requirement. If the user still likes to see the detailed information, the user can analyse the detailed measurement results of all involved test devices upon request.

1. A method of managing a communication network, wherein test devices are provided, and wherein a physical layer management system is provided for managing the physical attributes of the communication network, comprising the step of performing tests within the communication network using the test devices and managing the tests by a test strategy generator being comprised within the physical layer management system.

2. Method of claim 1, comprising the step of selecting a sequence, number and/or kind of tests depending on the number and/or kind of test devices.

3. Method of claim 1, comprising the step of selecting a sequence, number and/or kind of tests depending on the result/s of preceding tests.

4. Method of claim 1, comprising the step of providing a number of default tests and/or test sequences.

5. Method of claim 1, comprising the step of providing so-called if-then rules for building up a sequence of tests.

6. Method of claim 1, comprising the step of deciding a sequence of the tests in dependence of the test devices, which are actually present.

7. Method of claim 1, comprising the step of providing results of the tests to a user.

8. Method of claim 1 wherein detailed test results of different test devices are condensed into a quality statement.

9. Method of claim 8 wherein the quality statement is presented to a user and wherein the detailed test results are presented to the user upon request.

10. A method of managing a communication network, wherein test devices are provided and wherein a physical layer management system is provided for managing the physical attributes of the communication network, comprising the step of recognizing a new test device by a test strategy generator comprised in the physical layer management system.

11. Method of claim 10 wherein the new test device is introduced by plug-and-play and that specific minimum features are assigned by the test strategy generator to the new test device.

12. A system for managing a communication network, wherein test devices are provided, wherein a physical layer management system is provided for managing the physical attributes of the communication network, and wherein the physical layer management system comprises a test strategy generator for managing tests within the communication network using the test devices.

13. System of claim 12, wherein a fist interface is provided for coupling the test strategy generator and the test devices.
